(19) United States
(12) Patent Application Publication
(10) Pub. No.: US 2020/0187530 A1
(43) Pub. Date: Jun. 18, 2020

(54) Whole grain chips and a method for manufacturing thereof

(71) Applicant: Otkrytoe aktsionernoe obshchestvo "Khlebprom", Chelyabinsk (RU)

(72) Inventor: Kovalchuk Tatyana Grigorevna, Yartsevo (RU)

(21) Appl. No.: 16/547,064

(22) Filed: Aug. 21, 2019

(30) Foreign Application Priority Data
Dec. 18, 2018 (RU) 2018144841

(51) Int. Cl. A23L 7/13; A23L 27/10

(52) U.S. Cl. CPC A23L 7/13; A23V 2002/00; A23L 27/10

(57) ABSTRACT

A food product and a method for manufacturing thereof, in particular, manufacturing of a snack food product obtained by extruding and formed as chips, containing rice and corn grains, a natural flavoring additive with olive oil and rosemary, with cheese, with tomato and basil, with nacho cheese, with paprika and chili, the method including treating the rice and corn grits by purifying them from impurities and subsequent moistening with water, extruding the finished mixture of the grits with simultaneous baking and briquetting with double pressing, applying the flavoring additive on the surface of the chips by spraying.

### CROSS REFERENCE TO RELATED APPLICATION

This application is related to and claims the benefit of Russian Patent Application Number 2018144841 filed on Dec. 18, 2018, the entire contents of which are incorporated herein by reference in their entirety.

### TECHNICAL FIELD

This disclosure relates to a food product and a method for manufacturing thereof, in particular to manufacturing of a snack food product obtained by extruding and formed as chips, containing rice and corn grains, a natural flavouring additive with olive oil and rosemary, with cheese, with tomato and basil, with nacho cheese, with paprika and chili.

### BACKGROUND

A method for manufacturing of a snack product and a composition of the dough for manufacturing thereof are known from RF No. 2498623 published on 20 Nov. 2003. The method for manufacturing of the snack product consists in manufacturing of the dough, for which a lot of visible particles of cereal grains are mixed with the dough based on rice flour, a mixture of inulin and surfactant is added to the dough, while the amount of the inulin content is from about 1% to about 10% by the weight of the dough, the amount of the surfactant content is from about 0.01% to about 4.0% by the weight of the dough, and the amount of the said visible particles content is from about 2% to about 40% by the weight of the dough, the resulting dough is rolled to obtain a dough sheet with the thickness of from about 100 microns to about 2000 microns, the dough sheet is cut into separate pieces and fried, or the separate dough pieces are baked to obtain a variety of crispy rice products with the visible inclusions. The invention allows, through the use of the mixture of inulin and surfactant, eliminating a relationship between the water content and adhesiveness and viscoelasticity of the dough, what allows using the water content for controlling other variables of the product, such as a moisture content in the product and oil absorption, and also, using this mixture eliminates warping and sticking of the dough, when it is processed by the dough flattening rollers for tortilla.

The snack chips manufactured from the dough, which contain the grinded buckwheat husk, which average particle size corresponds to the size at which the particles in the amount of less than 20% by the weight pass through a 60-mesh sieve of the USA standard, are known from patent for an invention of the RF No. 2414128 published on 20 Mar. 2011. The dough for the snack chips and a method for manufacturing of the snack chips are also proposed. The method involves obtaining the grinded buckwheat husk and mixing it with the ingredients of the dough, rolling the dough to the thickness of from 0.015 inches to 0.25 inches and cutting the dough into separate pieces. The said dough pieces are exposed to a thermal treatment until the finished product moisture content reaches from 1 to 3% by the weight.

A device and a method for manufacturing of the figured snack food products are known from patent for an invention of the RF No. 2588539 published on 27 Jun. 2016. In one of the embodiments of the invention, the method for manufacturing of a variety of the figured food products involves forming the semi-finished food products, moving the semi-finished products to the forming oven, which contains the conveyor containing at least one convex press-form, and drying the semi-finished products in the forming oven for the purpose of obtaining the figured semi-finished products. Each figured semi-finished product may have a wave-type or wavy shape. At least one spring is provided, which can contain many spiral springs or at least one spring wire mesh. In another embodiment of the invention, the step of forming involves rolling the dough and cutting it into semi-finished products. The dough may be at least one of the following: corn flour dough, potato flakes dough, and wheat flour dough. In another embodiment of the invention, the method additionally involves final drying the figured semi-finished products with the purpose of obtaining the figured snack chips. Final drying may involve at least one of the following: frying in hot oil, drying with hot air, vacuum drying, jet drying, drying with infrared radiation or drying with ultra high frequency currents.

Thus, the snack food products, such as the finished corn chips of a tortilla or nachos type, are the popular products among the consumers for which there is high demand. At manufacturing of the snack food product, at first, the starchy dough is rolled, and then it is cut into the pieces of a desired shape and exposed to the thermal treatment. The desired shape of the snack food product is often a square, a triangle or a circle. After the dough is cut into pieces, they are exposed to the thermal treatment (for example, they are fried, baked, or both), resulting in the reduction of the moisture content in them. The snack food products are kept and packaged.

In order to obtain such flattened or sheet food products (for example, the chips of a tortilla or nachos type), such device as a dough sheeting roller is widely used in the food industry during a continuous technology process. Usually, the dough semi-finished product is squeezed between a pair of the device rolls rotating in the opposite direction, which are located near to each other, thereby creating a pinch zone, by means of which the sheets from the dough are obtained. Then the dough can be cut, for example, on the cutting roll in order to give the products the desired shape.

Many dough semi-finished products, particularly the corn-based ones, do not enter the conveyor to be moved to the next step of processing, such as a baking oven, but they tend to stick to the rolls of the device. One of the common methods for overcoming this complexity is to tension an ejector wire along a front side of the roll of the device, so that the ejector wire could separate the dough semi-finished products from a surface of the roll. A cutting knife can also be used to remove the dough from the surface of the rolls.

One of the essential disadvantages of the composition of the above said snack products is the use of flour and starch from which the dough is manufactured.

Thus, the snack products manufactured from the flour, which is obtained according to the conventional technology after grinding the grain, are characterized by an insignificant content of fiber, minerals and vitamins.

In recent years, there has been a sharp increase in demand for natural food products in general, and, in particular, for natural snack food products. The nutrient-rich snack products could meet ideally the various requirements involving the restrictions to the content of fat, including saturated and trans-fatty acids, cholesterol, sodium, and addable sugar and salt.

The popularity of the snack products from the whole grain is growing. The whole grain is considered to be the grain containing the whole pith of the grain (the bran, the germ and endosperm), at the same time, it may be a corn grain, a rice grain, etc. A typical indicator for the consumer of the fact that the product contains the whole grains is the presence of the visible bran particles in the product.

However, manufacturing of the snack products from the whole grain with the use of conventional rolling the dough is complex, because the bran or pericarpium will accumulate on the wire or the cutting knife of the dough sheeting roller, resulting in that the dough will be removed unevenly from the rolls. Therefore, this invention discloses the method for manufacturing of the snack product by extruding.

In addition, it would be useful to obtain the snack food product with the whole rice and corn grains with distinguished natural flavouring additives.

Thus, there is a need for the nutrient-rich snack chips with a high content of the whole grains that do not contain the components harmful to the human health, which are manufactured from an easily formed and exposable to extruding moistened mixture of rice and corn grains, followed by an addition of various flavouring additives.

The said disadvantages of the above products and the methods for manufacturing thereof disclosed in the prior art are eliminated by improving the composition and the method for manufacturing of the whole grain chips disclosed in this invention.

### DETAILED DESCRIPTION

This disclosure eliminates the disadvantages of the prior art, provides a snack product that is not capable of harming the health of the consumer, and expands a range of the bakery products.

The technical result of the disclosure resides in the implementation of the said product and the method for manufacturing thereof, as a result of which a new snack product being distinguished by its taste quality is obtained, which is intended for direct consumption as an additional source of fiber, mineral substances and vitamins.

The said technical result is achieved at the expense of the composition of the whole grain chips, which contain rice grits, corn grits, water, a flavouring additive, characterized in that the flavouring additive includes sunflower oil and/or olive oil, a rosemary extract and natural seasoning in the following ratio of the components, wt. %:

| | |
|---|---|
| water | 5.0-10.0 |
| rice grits | 30.0-44.0 |
| corn grits | 30.0-44.0 |
| sunflower oil and/or olive oil | 5.0-30.0 |
| a rosemary extract | 0.005-0.02 |
| natural seasoning | The rest. |

At the same time, the natural seasoning is selected from the group comprising at least one of tomato and basil, cheese, nacho cheese, paprika and chili.

At the same time, in one of the embodiments of the disclosure, the composition of the chips includes additionally the leguminous crops selected from the group containing bean, lentils, pea, chickpea, amarantus, quinoa, or their mixtures in the amount of 10.0-15.0 wt. %.

At the same time, the ratio of the different kinds of leguminous crops in the mixture may be, for example, 1:1 or 1:2; 1:3; 1:4 etc.

In addition, the said technical result is achieved due to the method for manufacturing of the whole grain chips, according to which the raw materials composition includes the use of rice grits, corn grits, water and the flavouring additive, which includes sunflower oil and/or olive oil, a rosemary extract and natural seasoning; treating the rice and corn grits by purifying them from impurities and subsequent moistening with water; extruding the finished mixture of the grits with simultaneous baking and briquetting with double pressing; applying the flavouring additive on the surface of the chips by spraying, the components for manufacturing of the whole grain chips being taken according to the above said qualitative and quantitative composition.

At the same time, moistening the mixture of the grits is performed in the vertical mixers by feeding there a calculated quantity of water, triple mixing during 7 minutes with the purpose of uniform mixing and a uniform distribution of water with subsequent keeping during 1-6 hours for swelling, while moisture of the finished moistened mixture of the grits is 14.5-19.0%.

At the same time, extruding the moistened mixture of the grits is performed under pressure of 120-160 bar between the press-forms heated up to the temperature of a top part of the stamp—250-260° C. and the temperature of a bottom part of the stamp—260-280° C.

At the same time, at the step of applying the flavouring additive, the sunflower or olive oil is heated up in a separately standing tank with a water jacket to room temperature, it is fed by a pump or under gravity into a panning drum, where it is sprayed onto the surface of the chips using the nozzles, while the seasoning or other spices, along with the oil, are fed into the panning drum and they are applied on the chips, which have already been covered with oil.

### IMPLEMENTATION OF THE DISCLOSURE

The uniqueness of the new product obtained by the claimed method (the whole grain chips) is that it is manufactured from the whole rice and corn grits, thereby the product has a high percentage (up to 60%) of the content of food fibers, and also, in one of the embodiments of the disclosure, it contains leguminous crops, which contain a lot of vegetable protein and vegetable fiber.

The product is a brittle product manufactured from the corn and rice grains with the addition of the flavouring mixture based on sunflower or olive oil with natural seasoning, with the possible addition of leguminous crops and (or) their mixtures, salt and protein powder. It is possible to add natural food flavours (flavouring substances—spices and condiments) to give a peculiar aroma and taste, it is possible to add natural food dyes to give a colour.

Extruding, which the treated (purified from impurities and moistened) grain is exposed to, is a complex physical and chemical process, which includes: thermal treating the product under pressure; a mechanochemical deformation of the product; an “explosion” of the product in a shock discharging front.

When extruded, the water in the grain boils at the high temperature, the grain bursts (swells) and, due to the high pressure, it is immediately formed into a briquette. As a result of thermal treating, the taste quality of the product is improved (a pleasant odour and taste), because various aromatic substances, etc. are formed, the enzyme activity to digest it increases significantly, the nutritional value of the product almost doubles.

Corn and rice enjoy an excellent reputation due to their nutritional value for the human nutrition. In addition, they also contain the coarse indigestible food fibers that help to remove toxins and slags from the body. The swollen rice grains have a beneficial effect on the intestinal peristalsis, normalize metabolism and they are the suppliers of the complex carbohydrates, which saturate and replenish the energy reserves for a long time. The product does not contain gluten, GMOs, artificial food dyes and flavours, preservation agents and it is a perfect supplement to nutrition.

The chips are manufactured in the form of the brittle light bars of various shapes. Depending on the technical peculiarities of the equipment, the shape of the product can be square, triangular, round (of different diameters), hearts-shaped or the product can have other shapes.

The product may contain vitamin or vitamin and mineral complexes (premixes).

The whole grain chips are covered with the flavouring additive on both sides.

The examples of the composition of specific products are given and the method manufacturing thereof is described in detail to serve evidence of the possibility of the implementation of the disclosure.

### Example 1

The whole grain corn-rice chips with paprika and chili.

| | The raw materials |
|---|---|
| The raw materials name | consumption, in wt. % |
| water | 5.00 |
| rice grits | 44.00 |
| corn grits | 30.00 |
| sunflower oil | 5.00 |
| a rosemary extract | 0.005 |
| natural seasoning with paprika and chili | 15.995 |
| Total | 100.00 |

### Example 2

The whole grain corn-rice with nacho cheese.

| | The raw materials |
|---|---|
| The raw materials name | consumption, in wt. % |
| water | 10.00 |
| rice grits | 30.00 |
| corn grits | 44.00 |
| sunflower oil | 10.00 |
| a rosemary extract | 0.02 |
| natural seasoning with nacho cheese | 4.98 |
| Total | 100.00 |

### Example 3

The whole grain corn-rice chips with cheese.

| | The raw materials |
|---|---|
| The raw materials name | consumption, in wt. % |
| water | 7.00 |
| rice grits | 40.00 |
| corn grits | 30.00 |
| sunflower oil | 15.00 |
| a rosemary extract | 0.01 |
| natural cheese seasoning | 7.99 |
| Total | 100.00 |

### Example 4

The whole grain corn-rice chips with tomato and basil.

| | The raw materials |
|---|---|
| The raw materials name | consumption, in wt. % |
| water | 5.00 |
| rice grits | 44.00 |
| corn grits | 44.00 |
| sunflower oil | 5.00 |
| a rosemary extract | 0.01 |
| natural seasoning with tomato and basil | 1.99 |
| Total | 100.00 |

### Example 5

The whole grain corn-rice chips with olive oil and rosemary.

| | The raw materials |
|---|---|
| The raw materials name | consumption, in wt. % |
| water | 5.00 |
| rice grits | 30.00 |
| corn grits | 32.00 |
| olive oil | 30.00 |
| a rosemary extract | 0.005 |
| natural seasoning with olive oil and rosemary | 2.995 |
| Total | 100.00 |

### Example 6

The whole grain corn-rice chips with pea.

| | The raw materials |
|---|---|
| The raw materials name | consumption, in wt. % |
| water | 5.00 |
| rice grits | 30.00 |
| corn grits | 30.00 |
| pea | 15.00 |
| olive oil | 15.00 |
| a rosemary extract | 0.01 |
| natural seasoning with salt and rosemary | 3.99 |
| protein powder | 1.00 |
| Total | 100.00 |

### Example 7

The whole grain corn-rice chips with bean.

| | The raw materials |
|---|---|
| The raw materials name | consumption, in wt. % |
| water | 5.00 |
| rice grits | 30.00 |
| corn grits | 30.00 |
| bean | 10.00 |
| olive oil | 15.00 |
| a rosemary extract | 0.01 |
| natural seasoning with salt and rosemary | 4.99 |
| protein powder | 5.00 |
| Total | 100.00 |

### Example 8

The whole grain corn-rice chips with chickpea and quinoa.

| | The raw materials |
|---|---|
| The raw materials name | consumption, in wt. % |
| water | 5.00 |
| rice grits | 30.00 |
| corn grits | 30.00 |
| chickpea | 5.00 |
| quinoa | 5.00 |
| olive oil | 15.00 |
| a rosemary extract | 0.01 |
| natural seasoning with salt and rosemary | 4.99 |
| protein powder | 5.00 |
| Total | 100.00 |

The method for manufacturing of the product involves the following steps:
treating the raw materials;
composing the mixture;
extruding and briquetting;
applying the flavouring additive;
packaging and labelling the product.

Treating the raw materials.

Treating the raw materials involves the following operations:
screening the grain;
washing the grain;
moistening.

Screening.

The corn and rice grits, and the leguminous crops, if they are envisaged by the recipe, are screened with the purpose of removal of the impurities differing from the grits by the width, thickness and the aerodynamic properties. The raw materials are passed through the grain purification unit BSH-1 or Almaz (it is possible to use the separators of other brands and other manufacturers) with the magnetic detectors and the sieves with the different diameters of the cells, depending on the kind of the grits.

Washing.

The corn and rice grits, and the leguminous crops are washed separately, if they are envisaged by the recipe, at the wash machine KVD-1 (it is possible to use the wash machine of another brand and another manufacturer), intended for clearing a surface of grits and leguminous crops, if they are envisaged by the recipe, and separating them from the impurities differing by the hydrodynamic properties.

Moistening.

Moistening is an important technological operation that influence on the quality of the finished product. Moistening the grits is performed in mixers, both of the vertical and horizontal types. The amount of the water required for moistening depends on the kind of the grits and their initial moisture, and it is 2.8-3.5% of the weight of the loadable grits. Moisture of the treated raw materials should be 14.5-19%.

Moisture occurs by loading the corn and rice grits into the mixer, feeding there the calculated amount of water, triple mixing during 7 minutes with the purpose of uniform mixing and a uniform distribution of water with subsequent keeping during 30-60 hours for the grits swelling.

After the end of the process of moistening, the corn and rice grits should be kept during 1-6 hours, depending on the quality of the used grits.

Composing the mixture.

The mixture of the grits is composed from the treated raw materials according to the approved recipes, depending on the kind of the product.

Extruding and briquetting.

The manufacture of the product is performed at a special equipment and it involves extruding the mixture of the grits and simultaneous baking and briquetting with double pressing the obtained product. The technological parameters at this step are the temperature of the top and bottom stamps and the heating-up time. These parameters depend on the processable mixture of the grits and are:

The temperature of the top part of the stamp is 250-260° C.;

The temperature of the bottom part of the stamp is 260-280° C.;

The time of baking is 6-8 seconds;

The pressure is 120-160 bar.

Applying the flavouring additive from the vegetable oil and the natural seasoning on the whole grain chips.

The vegetable oil (high oleic sunflower or olive oil) is heated up in the separately standing tank with the water jacket to room temperature, and it is fed by the pump or under gravity into the panning drum, where it is sprayed onto the surface of the chips using the nozzles. The seasoning or other spices, along with the oil, are fed into the panning drum and they are applied on the chips, which have already been covered with oil.

This is followed by the steps of packaging and labeling, transporting and storing.

The given examples of a specific implementation allow determining an optimal ratio of the components for the whole grain chips and obtaining a wholesome product with the high organoleptic characteristics of quality and with a high nutritional value suitable for functional nutrition.

1. A composition of whole grain chips comprising:
rice grits,
corn grits,
water, and
a flavoring additive,
wherein the flavoring additive includes sunflower oil and/or olive oil, a rosemary extract and natural seasoning in the following ratio of components, wt. %:

| | |
|---|---|
| water | 5.0-10.0 |
| rice grits | 30.0-44.0 |
| corn grits | 30.0-44.0 |
| sunflower oil and/or olive oil | 5.0-30.0 |
| a rosemary extract | 0.005-0.02 |
| natural seasoning | The rest. |

2. The composition of claim 1, wherein the natural seasoning comprises at least one of tomato and basil, cheese, nacho cheese, paprika and chili.

3. The composition of claim 1, further comprising a leguminous crop comprising at least one of bean, lentils, pea, chickpea, amarantus, quinoa, and mixtures thereof in an amount of 10.0-15.0 wt. %.

4. A method for manufacturing of whole grain chips composed of rice grits, corn grits, water and a flavoring additive, which includes sunflower oil and/or olive oil, a rosemary extract and natural seasoning, the method comprising:
treating the rice and corn grits by purifying them from impurities and subsequent moistening with water;
extruding the finished mixture of the grits with simultaneous baking and briquetting with double pressing;
applying the flavoring additive on the surface of the chips by spraying,
the components for manufacturing of the whole grain chips being taken in the following ratio of the components, wt. %:

| | |
|---|---|
| water | 5.0-10.0 |
| rice grits | 30.0-44.0 |
| corn grits | 30.0-44.0 |
| sunflower oil and/or olive oil | 5.0-30.0 |
| a rosemary extract | 0.005-0.02 |
| natural seasoning | The rest. |

5. The method of claim 4, wherein the natural seasoning comprises at least one of tomato and basil, cheese, nacho cheese, paprika and chili.

6. The method of claim 4, wherein the composition of the chips includes additionally a leguminous crop comprising at least one of bean, lentils, pea, chickpea, amarantus, quinoa, or mixtures in the amount of 10.0-15.0 wt. %.

7. The method of claim 4, wherein the moistening the mixture of the grits is performed in a vertical mixer by feeding a calculated quantity of water, triple mixing for about seven minutes to attain a uniform mixing and a uniform distribution of water with subsequent keeping for about one to six hours for swelling, wherein moisture of the finished moistened mixture of the grits is about 14.5-19.0%.

8. The method of claim 4, wherein extruding the moistened mixture of the grits is performed under pressure of about 120-160 bar between press-forms heated up to a temperature of a top part of the stamp—of about 250-260° C. and a temperature of a bottom part of the stamp—of about 260-280° C.

9. The method of claim 4, wherein, at the step of applying the flavoring additive, the sunflower or olive oil is heated up in a separately standing tank with a water jacket to room temperature, is fed by a pump or under gravity into a panning drum, where it is sprayed onto surfaces of the chips using nozzles, while seasoning or other spices, along with the oil, are fed into the panning drum and applied on the chips, which have already been covered with oil.
